(19) United States
(12) Patent Application Publication
(10) Pub. No.: US 2025/0148156 A1
(43) Pub. Date: May 8, 2025

(54) METHOD AND DEVICE FOR ANALYZING A REAL FORM OF AN AERODYNAMIC SURFACE OF A PART

(71) Applicants: Airbus Operations SAS, TOULOUSE (FR); Metrologic Group SAS, MONTBONNOT-SAINT MARTIN (FR)

(72) Inventors: Cyril BONNAUD, TOULOUSE (FR); Franck DOBIGEON, TOULOUSE (FR); Emeric CHANCERELLE, ROCHEFORT (FR); Rémi TRAN-TIEN, MONTBONNOT-SAINT MARTIN (FR); Pierre VIALLET, MONTBONNOT-SAINT MARTIN (FR); Florian SALETTE, MONTBONNOT-SAINT MARTIN (FR)

(21) Appl. No.: 18/937,734

(22) Filed: Nov. 5, 2024

(30) Foreign Application Priority Data
Nov. 8, 2023 (FR) 2312101

(51) Int. Cl. G06F 30/17

(52) U.S. Cl. CPC G06F 30/17

(57) ABSTRACT

A method and a device for analysis of a profile of a real form of a surface of a part. The device determines and divides into subsections a deviation between the real form and the theoretical form. Then, for each subsection, a sinusoidal wave characterized by an amplitude b and a half-length of wave a is identified. When b is smaller than a predetermined value bₘᵢₙ or when a is smaller than a predetermined value aₘᵢₙ, then the device stops the analysis, otherwise a new iteration of the analysis is carried out, considering the sinusoidal wave identified as a new profile of a theoretical form of the surface. Upon completion of the analysis phase, an alert message is generated if the values b and/or b/a do not comply with a manufacturing tolerance criterion.

### CROSS-REFERENCES TO RELATED APPLICATIONS

This application claims the benefit of French Patent Application Number 2312101 filed on Nov. 8, 2023, the entire disclosure of which is incorporated herein by way of reference.

### FIELD OF THE INVENTION

The present invention concerns a method and a device for analyzing the real form, i.e. manufactured or deformed under application of a load, of an aerodynamic surface of a part subjected to a stream of flow which is required to be laminar, such as, for example, a part of an aircraft. In particular, the method and the device according to the invention concern the identification of differences between the form of the real surface of such a part and its theoretical form.

### BACKGROUND OF THE INVENTION

The increase in the price of fuel and the need to reduce the environmental impact of the exploitation of airline companies have led to the discovery of new technologies which make it possible to solve these problems.

Among these new technologies, aircraft parts (for example: wings, tail units, engine air intakes, etc.) with Natural Laminar Flow (NLF) make it possible to reduce fuel consumption and greenhouse gas emissions in commercial aviation. In fact, maintenance of a laminar flow instead of a turbulent flow on an aerodynamic surface makes it possible to reduce the coefficient of friction of this surface considerably, and thus to optimize the performance levels of an aircraft.

Obtaining a natural laminar flow is in particular conditioned by the form of the aerodynamic surface of an aircraft part, such as an engine air intake. The theoretical form (i.e., as planned during the design) of the engine air intake surface of an NLF type has evolutionary curvature in all directions (longitudinal and azimuth), which makes it possible in particular to obtain a natural laminar flow of this type. In addition, the surface of the engine air intake must be kept smooth (i.e., having any roughness contained within a predefined tolerance margin) and free from defects (for example: insect residues, steps, holes, undulations, etc.) in order to maintain a natural laminar flow.

The following explanation concerning aircraft parts is given by way of illustration, and is applicable to the manufacture or design of other types of parts subjected to a stream of flow which is required to be laminar.

It should be noted that the form of the real surface of a part subjected to a stream of flow which is required to be laminar (for example an aircraft part as previously described), i.e., which is manufactured or deformed after application of a load, can have differences in relation to its theoretical form. For example, undulations may form on the surface of the part during manufacture, or when the part in question is subjected to a load. FIG. 1 illustrates for example schematically different geometries of undulations which may form on the surface of an aircraft part during the manufacture or after application of a load. In FIG. 1, at a given location of the part, three examples of 2-D cross-sections of the surface are presented. A first example of a cross-section has an undulation indicated as C1, a second example of a cross-section has an undulation C2, and a third example of a cross-section has an undulation C3. Each undulation, or wave, is characterized by an amplitude indicated as b and a half-length of wave indicated as a. The undulation C1 is then represented in broken lines, by way of reference, on the undulations C2 and C3. Although these three undulations C1, C2 and C3 have different geometries, they have values of amplitude b and half-length of wave a which are identical. It is these differences of geometry, or profile, of these undulations, which will play an important part in whether a natural laminar flow is maintained or not. In other words, if the profile of the undulation C1 is favorable to maintenance of a natural laminar flow, the undulations C2 and C3 have profiles which, on the contrary, can introduce a risk for the maintenance of such a laminar flow. It should be noted that the geometry of the undulations can be far more complex than that presented above in association with FIG. 1.

It is therefore desirable to analyze the real form of the surface of a part subjected to a stream of flow which is required to be laminar, such as an aircraft part, in particular by comparing it with its theoretical form, in order to identify differences which can give rise to a change from natural laminar flow into turbulent flow. For this purpose, there are different tools which make it possible to make this comparison, such as, for example, tools which are based on a 3-D scan of the real form of the surface of the part modelled by CAD (Computer Assisted Design) tools.

The use of a 3-D scan of the real surface (i.e. manufactured or deformed after application of a load) makes it possible to observe a multitude of waves with different forms, sizes and wavelengths, when this scan is compared with the theoretical form of this surface. However, the 3-D scanning tools can introduce noise into the measurements, which can accentuate the differences between the real form and the theoretical form.

The use of CAD tools makes it possible to analyze in greater depth the differences between the real form of the surface and its theoretical form.

However, when the theoretical form of the surface is curved, the curvature of the theoretical form can create a bias in the understanding of the undulation of the real surface. Thus, it is necessary to evaluate the difference between the real form and the theoretical form.

However, the real and theoretical forms are not necessarily in the same geometric frame of reference, which may make evaluation of the difference between the real form and the theoretical form complex. In order to correct this difference of frame of reference, a “best fit” can be carried out with these CAD tools by minimizing the distance between the two forms (or two cross-sections of the aircraft part in a 2-D environment). However, this type of operation can distort the understanding of the differences between the real form and the theoretical form, in particular at the start and end points of the 2-D cross-section analyzed.

Consequently, the perception of the undulation can be affected by poor understanding of the wavelengths and amplitudes involved.

Furthermore, the previous techniques have other limits. In fact, they do not make it possible to identify and quantify the difference between the curvatures of the real surface and the curvatures of the theoretical surface, in order to be able to control the differences, in particular during the manufacture of the aircraft. In particular, it is not possible to define geometric characteristics of the surface undulations which may be on the real surface of the part, in order to be able to evaluate their criticality on the laminarity of the flow, for example via a comparison with quantifiable criteria (for example: criterion of manufacturing tolerance).

Criteria exist however for surfaces of the NLF type which take into account in particular the characteristics of the undulations which can give rise to a transition from a laminar flow to a turbulent flow by means of different mechanisms in the limit layer (i.e., interface zone between a body and the surrounding fluid during a relative movement between the two).

For example, the research by Carmichael at the end of the 50s led to the definition of a so-called “Carmichael's” criterion on the undulation permissible for maintenance of a laminar flow.

This criterion applies in particular to the undulations, or waves, of a sinusoidal type, for which the maximal value of the ratio b/a compatible with a laminar flow is given by the following semi-empirical formula:
for simple waves, the permissible wave gradient is:

$$\frac{b}{a} = 2 \times {( \frac{59000 \times c \times {cos}^{2} φ}{2 \times α \times {Rec}^{\frac{3}{2}}} )}^{1 / 2} \qquad [ EQ . 1 ]$$

where:
b is the amplitude of the wave;
a is the half-length of the wave;
φ is the scanning angle;
Rec is the Reynolds number based on the line indicated as c.
for multiple waves (i.e. superimposition of a plurality of waves on one another), a multiplication factor smaller than 1 can be applied to the preceding equation, depending on the application concerned.

However, the use of Carmichael's criterion has certain limits:
the analysis may be distorted if the part manufactured is curved by design (case for example of an engine air intake of an NLF type);
the different profiles, or forms, of waves for given values a and b which are identical are not perceived (for example see FIG. 1 above).
   FIG. 2 illustrates schematically an example of a profile, or geometry, of a multiple wave. Certain geometries of multiple waves can lead to a biased conclusion when Carmichael's criterion is used. In this example, a small wave PO is seated on a longer wave LO. If Carmichael's criterion presented above is applied, then:
if b=0.35 mm for a=750 mm, then the wave is compatible with a laminar flow, since bₘₐₓ=0.38 mm for a multiple wave;
if b=0.07 m pour a=50 mm, then the wave is compatible with a laminar flow, since bₘₐₓ=0.10 mm for a multiple wave;
if b=0.42 mm for a=750 mm, then the wave is not compatible with a laminar flow since bₘₐₓ=0.38 mm for a multiple wave.

Thus, depending on the geometry of the wave taken into account for calculation of the Carmichael's criterion, the wave may or may not be compatible with a laminar flow. It is therefore not possible to determine with precision values of amplitude b and half-length of wave a making it possible to use Carmichael's criterion for undulations with complex profiles.

It is thus desirable to eliminate these disadvantages of the prior art. In particular, there is a need for a technique making it possible to analyze the undulations of the real form (manufactured or deformed under load) of an aerodynamic surface of an aircraft part, in particular of an engine air intake, by comparing it in particular with its theoretical form. In particular, it is desirable to provide a solution which makes it possible to evaluate whether the real form of the surface complies with tolerances (e.g., manufacturing tolerances) which guarantee that the stream of the flow (e.g., flow of air) will remain laminar.

### SUMMARY OF THE INVENTION

A method is proposed here for analyzing a profile of a real form of a 2-D cross-section of an aerodynamic surface of a part, implemented by an analysis device. The method comprises: adapting a geometric frame of reference in order to make the leading and trailing edges of the profile of the real form correspond to the leading and trailing edges of a profile of a theoretical form of the 2-D cross-section of the aerodynamic surface of the part. The method also comprises an analysis phase comprising the following steps: determining a deviation between the profile of the real form and the profile of the theoretical form of the 2-D cross-section, dividing the deviation into subsections, each subsection being defined by a part of the deviation comprising a start and an end, corresponding to points for which a value of the deviation is zero, then, for each subsection: (i) identifying a maximal sinusoidal wave consistent with the part of the deviation defining the subsection, to within a predefined margin, this maximal sinusoidal wave being characterized by a value of amplitude of wave b and a value of half-length of wave a, (ii) when the value of amplitude of wave b is smaller than a minimal predetermined value of amplitude bₘᵢₙ or when the value of half-length of wave a is smaller than a minimal predetermined value of half-length of wave aₘᵢₙ, then stopping the analysis phase for the subsection, otherwise, when the value of amplitude of wave b is greater than the minimal predetermined amplitude bₘᵢₙ and the value of half-length of wave a is greater than the minimal predetermined value of half-length of wave aₘᵢₙ, then carrying out a new iteration of the analysis phase, considering the maximal sinusoidal wave identified as a new 2-D cross-section of a theoretical form of the aerodynamic surface. Upon completion of the analysis phase, the method comprises: generating an alert message if the values of amplitude of wave b and/or of gradient of wave b/a of the maximal sinusoidal wave, or if at least one value of amplitude of wave b and/or of gradient of wave b/a of a series of maximal sinusoidal waves is greater than a manufacturing tolerance criterion.

It is thus possible to identify differences, or divergences, between the real form of the aerodynamic surface of a part subjected to a stream of flow which is required to be laminar, such as an aircraft part, and the theoretical form of this surface, by taking into account complex undulation profiles. In particular, it is possible to eliminate a potential bias which could be introduced by a different geometrical frame of reference between the real form of the surface and its theoretical form, and to analyze complex and arbitrary deviations of surface, such as they may be encountered during the process of manufacturing an aircraft part. In addition, it is possible to identify the different scales of undulation, from the long wavelengths to the small wavelengths, and to evaluate their geometric characteristics, with one undulation independently from the others. It is thus also possible to determine whether the deviation is acceptable or not for a given objective (e.g., maintenance of a natural laminar flow), according to a manufacturing tolerance criterion.

According to a particular embodiment, the alert message informs an operator of the presence of a defect of the real form of the aerodynamic surface of the part, with this alert message comprising a type of defect and/or a location of the defect of the real form of the aerodynamic surface of the part.

According to a particular embodiment, the alert message also comprises at least one proposal for corrective action of the defect.

According to a particular embodiment, the maximal sinusoidal wave comprises: a start and an end which are identical at the start and at the end of the subsection, a wavelength 2a corresponding to a length of the subsection and the amplitude b defining a maximal amplitude corresponding to an amplitude of the deviation of the subsection, to within the predefined margin.

According to a particular embodiment, the tolerance criterion is based on a Carmichael's criterion for the maintenance of a natural laminar flow at the aerodynamic surface of the part.

A method is proposed here for repair of an aerodynamic surface of the part comprising: analysis of a profile of a real form of a 2-D cross-section of the aerodynamic surface of the part by execution of an analysis method as previously described and implemented by an analysis device, and repair of the aerodynamic surface of the part by an operator if an alert message is generated by execution of the analysis method as previously described.

A device is proposed here for analysis of a profile of a real form of a 2-D cross-section of an aerodynamic surface of a part comprising electronic circuitry configured to implement: adaptation of a geometric frame of reference in order to make the leading and trailing edges of the profile of the real form correspond to the leading and trailing edges of a profile of a theoretical form of the 2-D cross-section of the aerodynamic surface of the part. The electronic circuitry is also configured to implement an analysis phase comprising the following steps: determination of a deviation between the profile of the real form and the profile of the theoretical form of the 2-D cross-section, division of the deviation into subsections, with each subsection being defined by a part of the deviation comprising a start and an end, corresponding to points for which a value of the deviation is zero, then, for each subsection: (i) identifying a sinusoidal wave consistent with the part of the deviation defining the subsection, to within a predefined margin, said maximal sinusoidal wave being characterized by a value of amplitude of wave b and a value of half-length of wave a, (ii) when the value of amplitude of wave b is smaller than a minimal predetermined value of amplitude bₘᵢₙ or when the value of half-length of wave a is smaller than a minimal predetermined value of half-length of wave aₘᵢₙ, then stopping the analysis phase for the subsection, otherwise, when the value of amplitude of wave b is greater than the minimal predetermined value of amplitude bₘᵢₙ and the value of half-length of wave a is greater than the minimal predetermined value of half-length of wave aₘᵢₙ, then carrying out a new iteration of the analysis phase, by considering the maximal sinusoidal wave identified as a new 2-D cross-section of a theoretical form of the aerodynamic surface. Upon completion of the analysis phase, the electronic circuitry is configured to implement: generation of an alert message if the values of amplitude of wave b and/or of gradient of wave b/a of the maximal sinusoidal wave, or if at least one value of amplitude of wave b and/or of gradient of wave b/a of a series of maximal sinusoidal waves is greater than a manufacturing tolerance criterion.

A computer program product is also proposed, comprising instructions giving rise to the execution, by a processor, of the method described above according to any one of its embodiments, when said instructions are executed by the processor. A storage support, storing such instructions, is also proposed.

### BRIEF DESCRIPTION OF THE DRAWINGS

The aforementioned characteristics of the invention, as well as others, will become more clearly apparent from reading the following description of at least one embodiment, said description being provided in relation with the appended drawings, in which:

FIG. 1 illustrates schematically different three different geometries of undulation which may form on the surface of an aircraft part during its manufacture or after application of a load;

FIG. 2 illustrates schematically an example of geometry of a multiple wave;

FIG. 3 illustrates in the form of a diagram an algorithm of analysis of the profile of the real surface of a cross-section of a part of an aircraft according to one embodiment;

FIG. 4 illustrates schematically examples of results obtained for certain steps of the algorithm described in association with FIG. 3;

FIG. 5 illustrates schematically an example of modelling of a result obtained for a subsection of a cross-section of a real surface of an aircraft part, after implementation of the algorithm described in association with FIG. 3; and

FIG. 6 illustrates schematically an example of hardware architecture of an analysis device according to one embodiment.

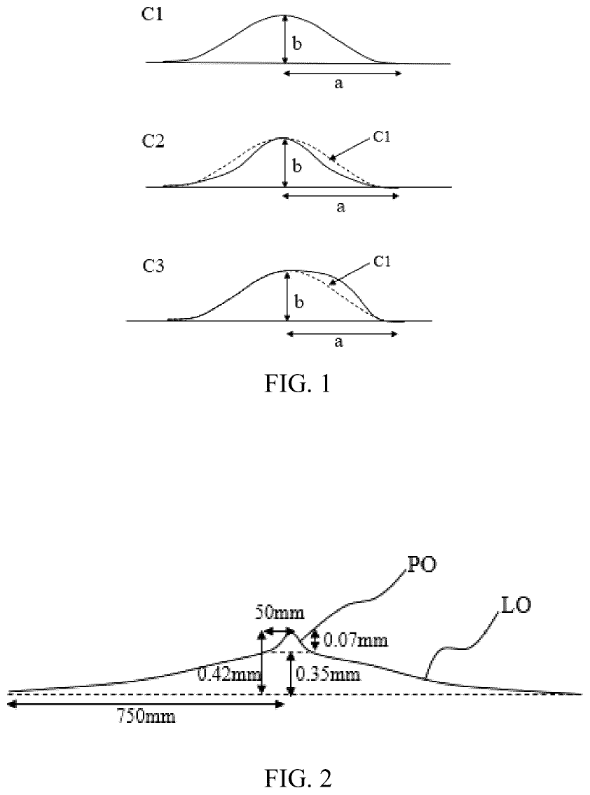

### DETAILED DESCRIPTION OF THE PREFERRED EMBODIMENTS

It is proposed here to analyze the real form of the aerodynamic surface of a part subjected to a stream of flow which is required to be laminar, such as, for example, an aircraft part, and in particular an engine air intake, by comparing it with its theoretical form. In particular, it is proposed here to identify and quantify the differences, or deviations, between the form of the theoretical surface of the part and that of the real surface, in order to determine the compatibility of the undulations which may form on the surface of the real part, with maintenance of a laminar flow. More specifically, the profile of the undulations of the real form of the surface is compared with the profile of the theoretical form of the surface, in order to evaluate whether the real form of the surface of the part complies with manufacturing tolerances, which guarantee that the flow will remain laminar. If the manufacturing tolerances are not complied with, then the method and the device make it possible to identify the position and extent of the defects, in order to define corrective actions. In one example, these corrective actions are: removing bosses (for example by manual or robotized sanding of the part), replacement of the part, reshaping of the part, etc.

Hereinafter, the terms “real surface” and “real form of the surface” designate respectively the surface and the form of the surface of an aircraft part after manufacture or after deformation associated with application of a load to the part.

The terms “profile” and “geometry” designate the form of the surface, and in particular the form of the undulations present on the real aerodynamic surface of the part. These terms are interchangeable.

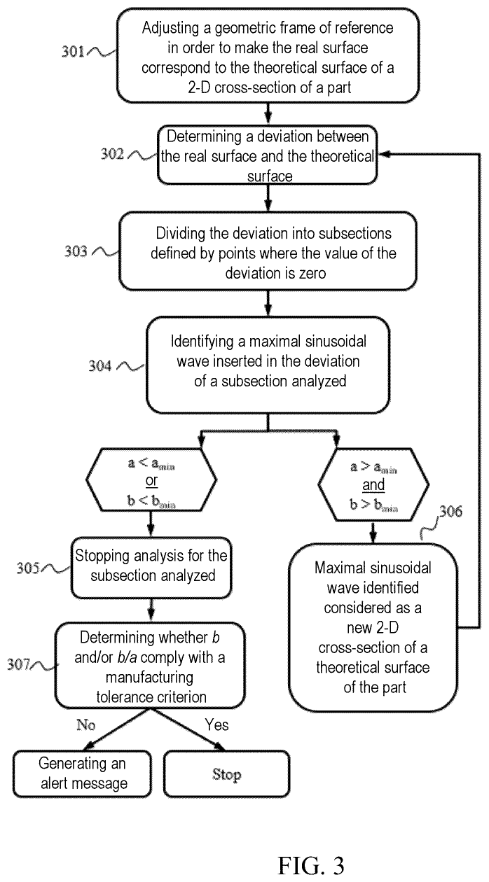

FIG. 3 illustrates in the form of a diagram an algorithm of analysis of the profile of the real surface of a cross-section of a part, in particular of an aircraft, according to one embodiment. The algorithm applies in particular, but without being limited to, the analysis of the real form of the surface of an engine air intake of the NLF type of an aircraft. Thus, the term “part” designates any part subjected to a stream of flow which is required to be laminar, and thus in particular to aircraft parts such as: an engine air intake of the NLF type, or any other type of part of an aircraft, such as, for example, a wing of an aircraft.

The algorithm described hereinafter takes as input data concerning the aerodynamic form of the theoretical surface of the part analyzed (e.g. engine air intake), and a series of data concerning the real form, i.e., the manufactured form, of this same part, or of a model of a part deformed under load. The data concerning the real form of the surface of the manufactured part are for example obtained via 3-D scanning of the part. The data concerning the theoretical form of the surface of the part of for example obtained via CAD. The data concerning the real form of the part deformed under the application of a load are for example obtained via a Finite Element Model (FEM). These data are for example data concerning dimensions, form (for example: curvature), undulations of the surface, etc.

The algorithm applies for example to a “2-D cross-section” of a 3-D geometry of the part to be analyzed, i.e., to a series of points representative of this part, situated on a plane. In another example, the algorithm applies to a so-called “non-plane” 2-D cross-section (i.e., obtained from the intersection between the real surface to be analyzed and a non-plane surface, i.e., which is curved selectively), in order to follow the natural direction of the flow of air on the surface of the part.

Thus the term “cross-section analyzed” refers to a 2-D cross-section extracted for example from a 3-D scan of the manufactured part (for example in the form of a cloud of points) or from an FEM result of a part deformed by a load.

The algorithm described hereinafter is implemented by a surface profile analysis device DISP 600 (also known as DISP 600 analysis device), presented hereinafter in association with FIG. 6. This DISP 600 analysis device is for example a computer.

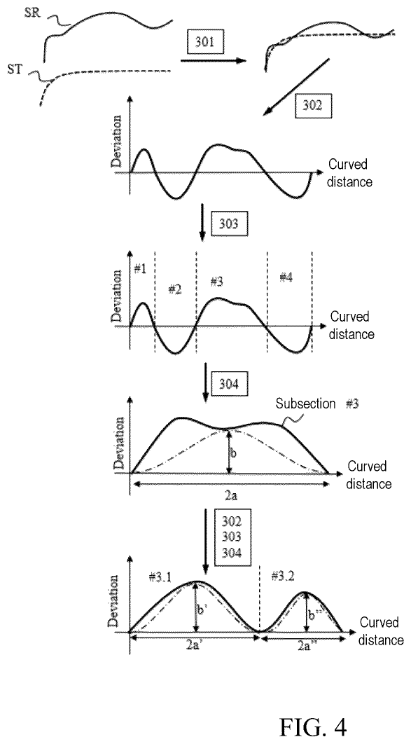

FIG. 4 illustrates schematically an example of a result obtained for certain steps of the algorithm described in association with FIG. 3, for a cross-section to be analyzed of the part. Firstly, FIG. 4 illustrates schematically an example of a 2-D cross-section of the real surface, indicated as SR, of a part of the part, and a 2-D cross-section, indicated as ST, of the theoretical surface of this same part.

During a step 301, the DISP 600 analysis device adjusts a geometric frame of reference in a relative manner between the form of the real surface and the form of the theoretical surface of the 2-D cross-section of the part. This adjustment makes it possible to make the leading and trailing edges of the 2-D cross-section of the real surface SR (i.e., manufactured or deformed under load) correspond to the leading and trailing edges of the 2-D cross-section of the theoretical surface ST of the part to be analyzed. This action of adjustment of the frame of reference of the 2-D cross sections of the real surface and of the theoretical surface may for example require the application of a translation and/or a rotation of the data for the cross-section of the part to be analyzed. It is thus possible to correct any difference of geometric frame of reference, and to show the differences, or deviations, between the profile of the theoretical surface ST of the cross-section and the profile of the real surface SR of the cross-section to be analyzed (also known hereinafter as the real cross-section SR). In addition, since a localized point on the surface of the part corresponds to each point of the 2-D cross-section to be analyzed, it is also possible to determine the position, or location, of the differences on the real surface of the part. If applicable, it is thus possible to locate defects on the real surface of the part.

The DISP 600 analysis device then implements a phase of analysis of the real cross-section SR, or, if applicable, a subsection of the real cross-section SR. This analysis phase comprises the steps 302 to 306 described hereinafter.

During the step 302, the DISP 600 analysis device calculates, for each point of the 2-D cross-section of the real surface SR, the curved distance (i.e., distance in relation to the 2-D cross-section of the theoretical surface ST for this same point) between the real surface SR of the cross-section to be analyzed and the theoretical surface ST of this same cross-section. The DISP 600 analysis device thus determines a deviation comprising a series of differences of distance between the profile of the real surface and the profile of the theoretical surface of the cross-section to be analyzed. In one example, this deviation is then represented in the form of a curve having all of the differences of distance between the real surface SR of the cross-section to be analyzed and its theoretical surface ST, according to the curved distance on the theoretical surface ST (see FIG. 4) of this cross-section.

During the step 303, the DISP 600 analysis device divides, or fragments, the deviation of the real surface SR of the cross-section to be analyzed into a plurality of parts, thus defining a series of subsections defined by the points where the value of the deviation is zero (i.e., points of the 2-D cross-section of the surface at which there is no difference, or no divergences, between the real surface SR and the theoretical surface ST). In the example in association with FIG. 4, the graphic representation of the deviation is divided into 4 subsections indicated as #1 to #4. Each subsection thus comprises a start point and an endpoint corresponding to points of the real surface SR of the cross-section to be analyzed, the value of the deviation of which is zero in relation to the theoretical surface ST of the cross-section to be analyzed.

During the step 304, for a given subsection (for example the subsection #3), the DISP 600 analysis device identifies the largest sinusoidal wave (or sine), known as the maximal sinusoidal wave. This maximal sinusoidal wave is consistent with the deviation of the subsection analyzed (i.e., subsection #3), in other words the amplitude of the maximal sinusoidal wave is close to the amplitude of the deviation of the subsection over all of the subsection, as described hereinafter. This maximal sinusoidal wave has a start point and an end point which are identical to the start and end points of the subsection analyzed. In addition, this maximal sinusoidal wave comprises a wavelength indicated as 2a defining the length of the subsection analyzed (a thus being the half-length of wave of the maximal sinusoidal wave), and an amplitude indicated as b defining the maximal amplitude of the sinusoidal wave in an interval of values incorporating the amplitude of the deviation of the subsection analyzed. In other words, the value of the amplitude of the maximal sinusoidal wave is contained in an interval of values incorporating the value of the amplitude of the deviation of the subsection over all of the subsection (i.e., the limits of the interval are defined such that: the upper limit is equal to the value of a predefined threshold plus the value of the amplitude of the deviation of the subsection over all of the subsection, and the lower limit is equal to the amplitude of the deviation of the subsection over all of the subsection less the value of the predefined threshold). This interval of values thus defines a predefined margin taken into account for the definition of the maximal amplitude of the sinusoidal wave. The maximal amplitude of the sinusoidal wave is thus consistent with the amplitude of the deviation of the subsection over all of the subsection, in consideration of this predefined margin.

During the step 305, the DISP 600 analysis device stops the analysis phase if the half-length of wave a or the amplitude b of the sinusoidal wave identified reach values lower than respective predefined thresholds aₘᵢₙ and bₘᵢₙ.

During the step 306 on the other hand, if the values of half-length of wave a and amplitude of wave b are respectively greater than the predefined thresholds aₘᵢₙ and bₘᵢₙ, the DISP 600 analysis device determines that the maximal sinusoidal wave identified in the step 304 is a new 2-D cross-section of a theoretical surface of the part. The DISP 600 analysis device thus reiterates the analysis phase by repeating the steps 302 onwards, in a loop, until the conditions for stopping the analysis phase are fulfilled. More specifically, the DISP 600 analysis device determines that the maximal sinusoidal wave identified in the step 304, thus known as the “mother” sinusoidal wave, is a 2-D cross-section of a theoretical form of the surface. The DISP 600 analysis device then determines (step 302) one or more differences between this new 2-D cross-section of the theoretical surface and a part of the deviation forming the subsection previously analyzed (for example subsection #3). The DISP 600 analysis device divides this subsection, known as the “mother” subsection, into new subsections (step 303), known as “daughter” subsections (for example subsections #3.1 and #3.2). For each “daughter” subsection (step 304), the DISP 600 analysis device identifies a maximal sinusoidal wave. The DISP 600 analysis device thus repeats the steps 305 or 306 according to the result of the comparison of the values of half-length of wave a and amplitude of wave b of the maximal sinusoidal waves identified for each “daughter” subsection (for example values a′ and b′ of the maximal sinusoidal wave of the subsection #3.1 and the values a″ and b″ of the maximal sinusoidal wave of the subsection #3.2) respectively at the predefined values aₘᵢₙ and bₘᵢₙ.

These repetitions of the analysis phase, or analysis in cascade, are thus carried out for all the “mother” subsections (for example the subsections #1 to #4) and their “daughter” subsections if necessary.

Thus, at the end of the algorithm, for a “mother” subsection analyzed, on the basis of the potential “daughter” subsections, the DISP 600 analysis device identifies a series or set of sinusoidal waves which are cumulated on one another.

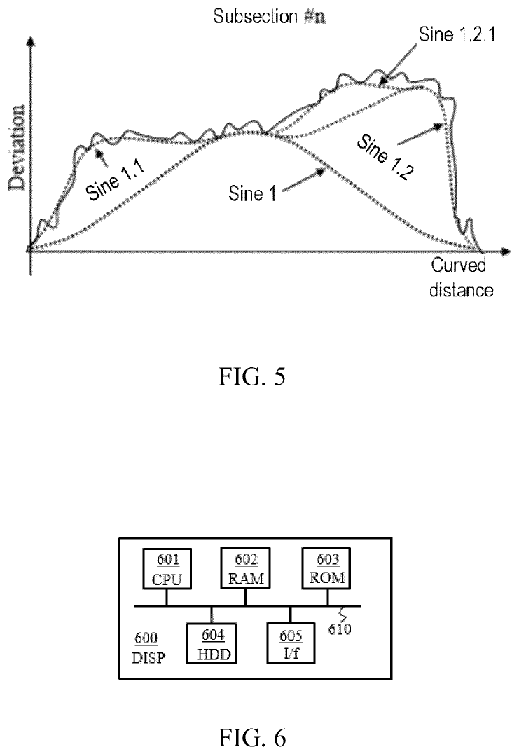

FIG. 5 illustrates schematically an example of a result obtained after implementation of the algorithm described in association with FIG. 3, for a given subsection of a 2-D cross-section of an aircraft part.

More particularly, FIG. 5 represents in graphic form the deviation of the 2-D cross-section of the real surface analyzed at a subsection #n according to the curved distance on its theoretical surface. This subsection #n has a particularly complex profile, with a plurality of undulations on one another and/or after one another. When the DISP 600 analysis device ends the analysis phase (i.e., steps 302 to 305 or 306) of this subsection #n, the deviation between the real form of the subsection #n and the theoretical form of this cross-section is broken down into a series of sinusoidal waves comprising:
a “mother” sinusoidal wave indicated as Sine 1 for the mother subsection #n;
“daughter” sinusoidal waves indicated as Sine 1.1, Sine 1.2 for the daughter subsections #n.1 and #n.2;
a “granddaughter” sinusoidal wave indicated as Sine 1.2.1 obtained from a new iteration of the analysis phase carried out on the basis of the “daughter” subsection #n.2 and which are cumulated on one another, for each subsection and their potential “daughter” subsections.

Thus, for each maximal sinusoidal wave identified for a “mother” subsection and its potential “daughter” subsections, the following characteristics are known:
position on the subsection and thus on the 2-D cross-section analyzed;
half-length of wave a;
amplitude b (can be positive or negative).

During a step 307, these characteristics of half-length of wave a and of amplitude b of each “mother” subsection and its potential “daughter” subsections can thus be compared with a manufacturing tolerance criterion. This tolerance criterion can be defined for example by:
a maximal value of amplitude of wave b for a given value of half-length of wave a (for example Carmichael's criterion);
a minimal value of half-length of wave a for a given value of amplitude of wave b;
a maximal value of the gradient b/a for a given half-length of wave a;
a combination of these tolerance criteria,
   in order to determine if the quality of the real form of the surface of the part is acceptable for a given objective.

This objective is for example an objective of maintenance of a laminar flow for an engine air intake of an aircraft. In this case, the manufacturing tolerance criterion is for example based on the Carmichael's criterion previously described. It is thus possible to assure a link with existing criteria of acceptance of the undulation, such as the Carmichael's criterion, by means of the parameters a (half-length of wave) and b (amplitude) of the individual maximal sinusoidal waves.

In another embodiment, the manufacturing tolerance criterion is based on the Carmichael's criterion for the so-called “mother” subsections, whereas a different manufacturing tolerance criterion (e.g. a maximal value of the gradient b/a for a given half-length of wave a) is applicable for the so-called “daughter” subsections.

Thus, for each subsection of the 2-D cross-section of the real surface SR to be analyzed, one or more maximal sinusoidal waves are identified. For each maximal sinusoidal wave identified, the pair a (half-length of wave) and b (amplitude) is compared with the manufacturing tolerance criterion (for example Carmichael's criterion). Thus, when a subsection can be characterized by a series of sinusoidal waves, then if at least one pair a (half-length of wave) and b (amplitude) characterizing a sinusoidal wave of the subsection does not comply with the manufacturing tolerance criterion, then it is the series of the subsection which does not comply with this manufacturing tolerance criterion.

In one example, when the manufacturing tolerance criterion is based on the Carmichael's criterion, for maintenance of a natural laminar flow, then the manufacturing tolerance criterion is a maximal value of amplitude of wave bₘₐₓ for a given value of half-length of wave a.

It should be noted that the position of the non-conformity, or non-compliance with the manufacturing tolerance criterion, is important for identifying the part of the part on which the laminarity of the flow is adversely affected.

In fact, on the basis of this manufacturing tolerance criterion, the DISP 600 analysis device can identify and locate a defect (i.e., corresponding to a deviation from the real form in relation to the theoretical form) on the surface of the air intake, when the values of b are greater than the tolerance criterion permitted. In the above example, the manufacturing tolerance criterion is based on the Carmichael's criterion, thus if b>bₘₐₓ for a given a, then the maintenance of the natural laminar flow is adversely affected, and actions must be put into place to repair the defect identified.

For this purpose, the DISP 600 analysis device generates an alert message destined for a man-machine interface (for example graphic and/or audible) used by an operator/technician. In a particular embodiment, this alert message comprises information on the type of fault (e.g. holes, bosses, etc.) and/or information on location of the defect, for example. As a variant, this alert message also comprises at least one proposal for corrective actions which can be carried out by the operator/technician in order to repair the defect.

It is thus possible for the operator/technician to apply the actions necessary to repair this defect on the part, and in particular the engine air intake.

In other words, the analysis method as described above makes it possible to implement a method for repair of an aircraft part, in particular an engine air intake. In particular, thanks to the generation of an alert message comprising in particular a proposal for corrective actions, a technician/operator can carry out these actions for the repair of the aircraft part.

FIG. 6 illustrates schematically an example of hardware architecture of the DISP 600 analysis device, which thus comprises, connected by a communication bus 610: a processor or CPU (Central Processing Unit) 601; a RAM (Random Access Memory) 602; a ROM (Read-Only Memory) 603, for example a flash memory; a data storage device, such as an HDD (Hard Disk Drive), or a storage support reader, such as an SD (Secure Digital) card reader 604; and at least one communication interface 605 allowing the DISP 600 analysis device to interact with different systems for measurement of the form of an aerodynamic surface, such as the form of a surface of an engine air intake of an aircraft.

The processor 601 can execute instructions loaded in the RAM 602 from the ROM 603, from an external memory (not represented), from a storage support, such as an SD card, or from a communication network (not represented). When the DISP 600 analysis device is switched on, the processor 601 can read instructions from the RAM 602 and execute them. These instructions form a computer program giving rise to implementation by the processor 601 of the behavior, steps and the algorithm described here.

Some or all of the behavior, steps and the algorithm described here can thus be implemented in software form by execution of a series of instructions by a programmable machine, such as a DSP (Digital Signal Processor) or a microcontroller, or can be implemented in hardware form by a machine or a dedicated component (chip) or a dedicated series of components (chipset) such as an FPGA (Field-Programmable Gate Array) or an ASIC (Application-Specific Integrated Circuit). In general, the DISP 600 analysis device comprises electronic circuitry which is arranged and configured to implement the behavior, steps and the algorithm described here.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A method for analyzing a profile of a real form of a 2-D cross-section of an aerodynamic surface of a part, implemented by an analysis device, said method comprising:
adapting a geometric frame of reference in order to make leading and trailing edges of the profile of the real form correspond to leading and trailing edges of a profile of a theoretical form of the 2-D cross-section of the aerodynamic surface of the part, the method also comprising an analysis phase comprising the following steps:
determining a deviation between the profile of the real form and the profile of the theoretical form of the 2-D cross-section;
dividing the deviation into subsections, each subsection being defined by a part of the deviation comprising a start and an end, corresponding to points for which a value of the deviation is zero, then, for each subsection:
(i) identifying a maximal sinusoidal wave consistent with the part of the deviation defining the subsection, to within a predefined margin, said maximal sinusoidal wave being characterized by a value of amplitude of wave b and a value of half-length of wave a;
(ii) when the value of amplitude of wave b is smaller than a minimal predetermined value of amplitude bₘᵢₙ or when the value of half-length of wave a is smaller than a minimal predetermined value of half-length of wave aₘᵢₙ, then stopping said analysis phase for said subsection, otherwise, when the value of amplitude of wave b is greater than the minimal predetermined amplitude bₘᵢₙ and the value of half-length of wave a is greater than the minimal predetermined value of half-length of wave aₘᵢₙ, then carrying out a new iteration of the analysis phase, considering the maximal sinusoidal wave identified as a new 2-D cross-section of a theoretical form of the aerodynamic surface;
upon completion of the analysis phase, generating an alert message when the values of amplitude of wave b, or of gradient of wave b/a of the maximal sinusoidal wave, or both, or when at least one value of amplitude of wave b, or of gradient of wave b/a of a series of maximal sinusoidal waves, or both is greater than a manufacturing tolerance criterion.

2. The method as claimed in claim 1, wherein the alert message informs an operator of a presence of a defect of the real form of the aerodynamic surface of the part, with said alert message comprising a type of defect, or a location of the defect of the real form of the aerodynamic surface of the part, or both.

3. The method as claimed in claim 2, wherein the alert message further comprises at least one proposal for corrective action of said defect.

4. The method as claimed in claim 1, wherein the maximal sinusoidal wave comprises:
a start and an end which are identical at the start and at the end of the subsection;
a wavelength 2a corresponding to a length of the subsection; and
the least one value of amplitude of wave b defining a maximal amplitude corresponding to an amplitude of the deviation of the subsection, to within the predefined margin.

5. The method as claimed in claim 1, wherein the tolerance criterion is based on a Carmichael's criterion for a maintenance of a natural laminar flow at the aerodynamic surface of the part.

6. A method for repair of an aerodynamic surface of a part comprising:
analysis of a profile of a real form of a 2-D cross-section of the aerodynamic surface of the part by performing the method as claimed in claim 1 with an analysis device; and,
repair of the aerodynamic surface of the part by an operator when an alert message is generated.

7. A device for analysis of a profile of a real form of a 2-D cross-section of an aerodynamic surface of a part comprising electronic circuitry configured to implement:
adapting of a geometric frame of reference in order to make leading and trailing edges of the profile of the real form correspond to leading and trailing edges of a profile of a theoretical form of the 2-D cross-section of the aerodynamic surface of the part, the electronic circuitry is also configured to implement an analysis phase comprising the following steps:
determining a deviation between the profile of the real form and the profile of the theoretical form of the 2-D cross-section;
dividing the deviation into subsections, with each subsection being defined by a part of the deviation comprising a start and an end, corresponding to points for which a value of the deviation is zero, then, for each subsection:
(i) identifying a maximal sinusoidal wave consistent with the part of the deviation defining the subsection, to within a predefined margin, said maximal sinusoidal wave being characterized by a value of amplitude of wave b and a value of half-length of wave a;
(ii) when the value of amplitude of wave b is smaller than a minimal predetermined value of amplitude bₘᵢₙ or when the value of half-length of wave a is smaller than a minimal predetermined value of half-length of wave aₘᵢₙ, then stopping said analysis phase for said subsection, otherwise, when the value of amplitude of wave b is greater than the minimal predetermined value of amplitude bₘᵢₙ and the value of half-length of wave a is greater than the minimal predetermined value of half-length of wave aₘᵢₙ, then carrying out a new iteration of the analysis phase, considering the maximal sinusoidal wave identified as a new 2-D cross-section of a theoretical form of the aerodynamic surface;
upon completion of the analysis phase, generating an alert message when the values of amplitude of wave b, or of gradient of wave b/a of the maximal sinusoidal wave, or both, or when at least one value of amplitude of wave b, or of gradient of wave b/a of a series of maximal sinusoidal waves, or both is greater than a manufacturing tolerance criterion.

8. A non-transitory computer readable medium comprising:
instructions configured to perform the method as claimed in claim 1, when said instructions are executed by a processor.
